(19) United States
(12) Patent Application Publication
(10) Pub. No.: US 2024/0059986 A1
(43) Pub. Date: Feb. 22, 2024

(54) SELECTIVE HYDROCRACKING OF NORMAL PARAFFIN

(71) Applicant: CHEVRON U.S.A. INC., San Ramon, CA (US)

(72) Inventors: Joel SCHMIDT, Oakland, CA (US); Cong-Yan CHEN, Kensington, CA (US); Theodorus Ludovicus Michael MAESEN, Moraga, CA (US); Dan XIE, San Ramon, CA (US)

(73) Assignee: CHEVRON U.S.A. INC., San Ramon, CA (US)

(21) Appl. No.: 18/269,922

(22) PCT Filed: Dec. 29, 2021
(86) PCT No.: PCT/IB2021/062435

§ 371 Date: Jun. 27, 2023

Related U.S. Application Data
(60) Provisional application No. 63/132,008, filed on Dec. 30, 2020.

(51) Int. Cl. C10G 65/12

(52) U.S. Cl. CPC C10G 65/12; C10G 2300/70; C10G 2300/807; C10G 2300/1081

(57) ABSTRACT

Provided is a process for hydrocracking normal paraffins into lighter normal paraffins with minimal formation of iso-paraffins. The process comprises hydrocracking a hydrocarbon feedstock comprising normal paraffins under hydrocracking conditions. The reaction is run in the presence of a specific type of zeolite based catalyst which has been found to provide high conversion with minimal iso-paraffin products. In one embodiment, the zeolite is of the framework PWO. The reaction conducted in the presence of the zeolite based catalyst produces an n-paraffin rich product that needs no separation step before being fed to a steam cracker to produce lower olefins.

### CROSS REFERENCE TO RELATED APPLICATIONS

This application claims the benefit of priority to U.S. Provisional Patent Appl. Ser. No. 63/132,008, filed on Dec. 30, 2020, the disclosure of which is herein incorporated in its entirety.

### TECHNICAL FIELD

Process for hydrocracking normal paraffins into lighter normal paraffins with minimal formation of iso-paraffins.

### BACKGROUND

For a century, hydrocracking and catalytic cracking have been used to reduce the boiling point and to increase the H/C ratio of crude oils and coal-derived liquids in refineries. Inherently, these catalytic processes also increased the iso-paraffin content of the lighter fractions. This was desirable when the intended use of the cracking products was an internal combustion engine. However, crude oil is now increasingly used for chemical manufacture, and high iso-paraffin content has become an undesirable side effect of acid-catalyzed (hydro)cracking.

Nobel Laureate George Olah established that acid catalysts do not crack n-paraffins directly into n-paraffins. Instead acids first catalyze the conversion of n-paraffins into iso-paraffins, and only then do they crack the iso-paraffins. Consequently, a product slate with a high iso-paraffin content is generally considered the signature of acid-catalyzed cracking. By contrast, a product slate with a high n-paraffin content is the signature of thermal cracking (pyrolysis).

Historically, C₅₊ liquids rich in normal paraffins have been prepared by selectively extracting normal paraffins from mixtures, such as petroleum. This operation is relatively expensive and is limited to the content of normal paraffins in the feedstock. For example, harvesting particularly the longer paraffins from an adsorbent, e.g., in a pressure swing adsorption process, requires an expensive and convoluted desorption step. Normal paraffins can also be produced in the Fischer Tropsch process. However, the Fischer Tropsch process also generates heavy products that can fall outside of the range of use for the above applications. If these heavy products are converted into lighter products by hydrocracking over conventional acidic catalysts, an iso-paraffin-rich product will be obtained, not a normal paraffin-rich product.

Selective cracking of heavy normal paraffins to lighter normal paraffins has been disclosed in the art. For example, note U.S. Patent Publication No. 2007/0032692.

In G. E. Langlois, R. F. Sullivan, and Clark J. Egan, “Hydrocracking of Paraffins with Nickel on Silica-Alumina Catalysts—the Role of Sulfiding,” Symposium on The Chemical and Physical Nature of Catalysts Presented Before the Division of the Petroleum Chemistry, American Chemical Society, Atlantic City Meeting, Sep. 12-17, 1965 (Table 1, page B-128), the conversion of n-decane (n-C₁₀) over silica alumina with different metals during hydrocracking is described.

Nickel without sulfiding gives C₄-C₇ products with low i/n ratios (0.08), but the conversion of this catalyst is very low (7.8%), and methane yields are relatively high (0.28 wt. %). In comparison a sulfided nickel catalyst on the silica alumina has high conversion (52.8), and low methane yields (0.02 wt. %) but gives C₄-C₇ products with high i/n ratios (6.6). Catalysts are now described that have the combination of good activity, low i/n ratio products, and low methane make.

Jule A. Rabo, “Unifying Principles in Zeolite Chemistry and Catalysis,” in Zeolites: Science and Technology, editor F. Ramoa Ribeiro et al., NATO ACS Series Vol. 80, pages 291-316, 1984 (page 295-296) discloses the use of alkali-neutralized zeolites that are free of acidic hydroxyls for cracking hexane. However, this reference discloses cracking and not hydroconversion, and significant quantities of methane (3.1 wt. %) and olefins are produced.

Harry L. Coonradt and William E. Garwood, “The Mechanism of Hydrocracking,” I&EC Process Design and Development, Vol., 3 No. 1, January 1964 pages 38-45 describes the use of a platinum on silica alumina catalyst for hydrocracking hexadecane (n-C₁₆), n-heptane and n-docosane (n-C₂₀ also known as eicosane), while producing low levels of methane. Significant amount of cycloparaffins are also produced, and the product is isomerized (as noted on page 40, 1^{st} column), but the extent of isomerization is not known. While the pore properties of the support for this catalyst are not described, it probably was not microporous, as shown by the formation of cycloparaffins and iso-paraffins.

B. S. Greensfelder, H. H. Voge, and G. M. Good, “Catalytic and Thermal Cracking of Pure Hydrocarbons,” Industrial and Engineering Chemistry, November 1949, pages 2573-2584, describes the evaluation of different classes of catalysts for conversion of cetane (n-C₁₆). Of particular note, activated carbon gives lower yields of methane than a thermal reaction, but still produces significant amounts of methane and also significant amounts of ethane, propane and butane. It was noted that very little chain-branching (formation of iso-paraffins) was observed (page 2576, col 2, 2^{nd} paragraph). However, as with other cracking studies, significant quantities of olefins were produced, and yields of gases were excessive.

There is an urgent need in the industry to diversify the crude oil value chain away from fuels. It is now important to turn crude oil into a superior steam cracking feedstock. Iso-paraffins are a less desirable steam cracker feed stream in that they generate desirable olefins, but at the cost of significant quantities of undesirable pyrolysis oil. The industry would welcome a straight-forward and efficient catalytic process for hydroconverting normal paraffins into lighter normal paraffins with minimal formation of iso-paraffins.

### SUMMARY

Provided is a process for hydrocracking normal paraffins into lighter normal paraffins with minimal formation of iso-paraffins. The process comprises hydrocracking a hydrocarbon feedstock comprising normal paraffins under hydrocracking conditions. The feedstock generally comprises at least 3 wt. % normal paraffins, and in an embodiment at least 5 wt. % normal paraffins. The reaction is run in the presence of a specific type of zeolite-based catalyst which has been found to provide high conversion with minimal iso-paraffin products. The zeolite-based catalyst has a void greater than 0.35 nm in diameter accessible through channels with a shorter diameter greater than 0.30 nm and a longer diameter less than 0.50 nm. In one embodiment, the zeolite is of the framework PWO. The reaction conducted in the presence of the zeolite based catalyst produces an n-paraffin rich product that needs no separation step before being fed to a steam cracker to produce lower olefins.

Among other factors, the present process allows one to catalytically hydrocrack a n-paraffin containing feedstock with minimal iso-paraffin production. The present hydrocracking process thereby permits one to utilize a straight-forward and efficient catalytic process for hydroconverting normal paraffins into lighter normal paraffins while avoiding the present expensive and inefficient commercial separation processes.

### BRIEF DESCRIPTION OF THE FIGURES OF THE DRAWING

FIG. 1 is the XRD pattern of the PWO zeolite prepared in Example 1.

FIG. 2 is SEM images of the material prepared in Example 1.

FIG. 3 graphically depicts the conversion as a function of temperature for the run in Example 4.

FIG. 4 graphically depicts the cracking product distribution at the cracking yield of 31 mol. % for the run in Example 4.

FIG. 5 graphically depicts the cracking product distribution at the cracking yield of 44 mol. % for the run in Example 4.

FIG. 6 graphically depicts the cracking product distribution at the cracking yield of 60 mol. % for the run in Example 4.

FIG. 7 graphically depicts the cracking product distribution at the cracking yield of 90 mol. % for the run in Example 4.

### DETAILED DESCRIPTION

### Definitions

Hydroconversion and hydroconvert: A catalytic process which operates at pressures greater than atmospheric in the presence of hydrogen and which converts normal paraffins into lighter normal paraffins with a minimum of isomerization and without excessive formation of methane and ethane. Hydrotreating and hydrocracking are distinctly different catalytic processes but which also operate at pressures greater than atmospheric in the presence of hydrogen. Hydrocracking converts normal paraffins into lighter products comprising significant amounts of iso-paraffins. Hydrotreating does not convert significant quantities of the feedstock to lighter products but does remove impurities such as sulfur- and nitrogen-containing compounds. Also in comparative contrast, thermal cracking converts normal paraffins into lighter products with a minimum of branching, but this process does not use a catalyst, typically operates at much higher temperatures, forms more methane, and makes a mixture of olefins and normal paraffins.

An “aperture” in a zeolite is the narrowest passage through which an absorbing or desorbing molecule needs to pass to get into the zeolite's interior. The diameter of the aperture, dₐₚₚ (nm), is defined as the average of the shortest, dₛₕₒᵣₜ (nm), and the longest, d_{long} (nm) axis provided in the IZA (International Zeolite Association) Zeolite Atlas (http://www.iza-structure.org/databases/). Both normal- and iso-paraffins with a methyl group can pass through apertures with a d_{long}≥0.50 nm, but only normal-paraffins can pass through apertures with d_{long}<0.50 nm provided dₛₕₒᵣₜ>0.30 nm.

Apertures provide access to “voids”, the wider parts in the zeolite topology. The diameter of the void, d_{void} (nm), is characterized by the maximum diameter of a sphere that one can inflate inside such a void as per the IZA Zeolite Atlas (http://www.iza-structure.org/databases/). This characterizes e.g. a fairly spherical LTA-type void (or cage) as one with a diameter of 1.1 nm, and an elongated AFX-type void as one with a spherical diameter of 0.78 nm. Voids are defined as channels if d_{void}/dₐₚₚ<1.5 nm/nm. Channels need to contain moieties larger than 0.35, more preferably larger than 0.43 and most preferably larger than 0.50 nm in diameter to enable hydrocracking, e.g., a void in undulating ASV-type channels with a d_{void}=0.54 nm, and a void in intersecting PWO-type channels with a d_{void}=0.52 nm enable hydrocracking.

The present process hydroconverts normal paraffins into lighter normal paraffins with minimal formation of iso-paraffins. The process comprises hydroconverting a hydrocarbon feedstock comprising normal paraffins under hydrocracking conditions, in the presence of a zeolite based catalyst having a void greater than 0.35 nm in diameter accessible through channels with a shorter diameter greater than 0.30 nm and a longer diameter less than 0.50 nm. In one embodiment, the zeolite catalyst comprises a PWO-type zeolite based catalyst. Some of the key features of the PWO-type zeolite is that it has a pore system with access through apertures less than 0.45 nm in diameter and a pore system with voids greater than 0.5 nm in diameter. Also, loading the PWO zeolite with 0.1 to 0.5 wt. % Pd, reducing the catalyst and running it at about 80% n-C₁₀ conversion at about 600° F. (315° C.), 1200 psig total pressure, 0.5 LHSV and 5:1 H₂/n-C₁₀ molar ratio, the resulting iC₄/nC₄ in the product is less than 0.5; in another embodiment less than 0.25, and also less than 0.15 in another embodiment. This demonstrates the hydroconversion of n-paraffins with minimal formation of iso-paraffins. This demonstration can confirm any zeolite based catalyst as appropriate for the present process, as long as the topology requirements are met.

The PWO-type zeolite is unique in that it is comprised of 9-ring apertures. The zeolite is built from the 1,3-stellcited cubic building unit. As a result, the zeolite, instead of widening the cages (the largest void in the pore structure), it elongates the apertures (the smallest void in the pore structure), effectively turning a short 0.43 nm wide aperture into a long 0.44 nm wide channel. It has been surprisingly found that the topology preserves the void space to isomerize n-paraffins at the 0.52 nm wide intersections, but the long channel size is small enough to categorically exclude iso-paraffins from leaving the zeolite. This is thought to result in the high conversion of n-paraffins to lighter n-paraffin products, but with minimal iso-paraffin production.

PST-21 is a PWO-type zeolite that qualifies for use in the present processes. The zeolite is reported in Jo, D., Park, G. T., Shin, J. and Hong, S. B., 2018. “A Zeolite Family Nonjointly Built from the 1,3-Stellated Cubic Building Unit.” Angewandte Chemie, 130(8), pp. 2221-2225. See also South Korean Patent No. KR/01924731, granted Dec. 3, 2018. PST-21 is synthesized in fluoride media using the so-called “excess fluoride” method where the molar amount of fluoride used is greater than the organic. Example 1 below provides a detailed synthesis of PST-21. The Constraint Index of PST-21 is 6.4 (427° C., 1.0 h-LHSV), and is viewed as displaying exceptional activity towards steering the skeletal isomerization of 1-butene to isobutene. Nevertheless, it has been found that the PST-21 zeolite, a PWO-type zeolite, can hydrocrack normal paraffins to lighter normal paraffins with minimal formation of iso-paraffins.

The following table lists other zeolites having the necessary topology and structural characteristics to thereby be a zeolite base for a catalyst useful in the present process. The table provides examples of framework types identified by their IZA three-letter code. Included in the table is the PWO zeolite. In the table, the d-short, d-long, and d-sphere values are pore dimensions given in Angstroms at the IZA website. In the table, the values are given in Angstroms.

| | | | | Ratio of | | | ratio_d- |
|---|---|---|---|---|---|---|---|
| IZA | largest | | | d-long/ | | d- | sphere/ |
| Code | ring | d-short | d-long | d-short | d-avg | sphere | d-avg |
| MVY | 10 | 3.1 | 4.5 | 1.45 | 3.80 | 3.76 | 0.99 |
| VSV | 9 | 3.8 | 4.0 | 1.05 | 3.90 | 4.31 | 1.11 |
| JSN | 8 | 4.4 | 4.5 | 1.02 | 4.45 | 5.12 | 1.15 |
| PWO | 9 | 4.2 | 4.4 | 1.05 | 4.30 | 5.22 | 1.21 |
| DFT | 8 | 4.1 | 4.1 | 1.00 | 4.10 | 5.10 | 1.24 |
| VNI | 8 | 3.6 | 4.1 | 1.14 | 3.85 | 4.80 | 1.25 |
| ASV | 12 | 4.1 | 4.1 | 1.00 | 4.10 | 5.43 | 1.32 |
| EPI | 8 | 3.7 | 4.5 | 1.22 | 4.10 | 5.47 | 1.33 |
| LOV | 9 | 3.2 | 4.5 | 1.41 | 3.85 | 5.15 | 1.34 |
| RSN | 9 | 3.3 | 4.4 | 1.33 | 3.85 | 5.15 | 1.34 |
| ETV | 10 | 4.2 | 4.5 | 1.07 | 4.35 | 5.85 | 1.34 |
| ATT | 8 | 3.5 | 4.2 | 1.20 | 3.85 | 5.42 | 1.41 |
| CGS | 10 | 3.5 | 4.8 | 1.37 | 4.15 | 5.86 | 1.41 |
| OWE | 8 | 3.2 | 4.8 | 1.50 | 4.00 | 5.78 | 1.45 |
| CDO | 8 | 3.1 | 4.7 | 1.52 | 3.90 | 5.78 | 1.48 |

The hydrocracking or hydroconversion catalyst useful in the present processes typically comprises a catalytically active hydrogenation metal. The presence of a catalytically active hydrogenation metal leads to product improvement, especially VI and stability. Typical catalytically active hydrogenation metals include chromium, molybdenum, nickel, vanadium, cobalt, tungsten, zinc, platinum, and palladium. The metals platinum and palladium are especially preferred, with platinum most especially preferred. If platinum and/or palladium is used, the total amount of active hydrogenation metal is typically in the range of 0.1 wt. % to 5 wt. % of the total catalyst, usually from 0.1 wt. % to 2 wt. %.

In one embodiment, a zeolite in accordance with the present process, e.g., a PWO zeolite, is loaded with a hydrogenation function metal or a mixture of such metals. Such metals are known in the art. The preferred metal is typically either a noble metal, such as Pd, Pt, and Au, or a base metal, such as Ni, Mo and W. A mixture of the metals and their sulfides can be used. The loading of the zeolite with the metals can be accomplished by techniques known in the art, such as impregnation or ion exchange. The hydrogenation function metal is loaded on such a selected zeolite to create the catalyst. The created catalyst can then be used in the hydroconversion process.

The feedstock for the process is a hydrocarbon feedstock which comprises at least 5 wt. % normal paraffins. Greater benefit is achieved when the hydrocarbon feedstock comprises at least 20 wt. %, even better when at least 50 wt. % normal paraffins, and in particular at least 80 wt. % normal paraffins. Due to the high content of normal paraffins, the feedstock can be referred to as a waxy feed. Such feedstocks can be obtained from a wide variety of sources, including whole crude petroleum, reduced crudes, vacuum tower residua, synthetic crudes, foots oils, FischerTropsch derived waxes, and the like. Typical feedstocks can include hydrotreated or hydrocracked gas oils, hydrotreated lube oil raffinates, brightstocks, lubricating oil stocks, synthetic oils, foots oils, Fischer-Tropsch synthesis oils, high pour point polyolefins, normal alphaolefin waxes, slack waxes, deoiled waxes and microcrystalline waxes. Other hydrocarbon feedstocks suitable for use in processes of the present process scheme may be selected, for example, from gas oils and vacuum gas oils; residuum fractions from an atmospheric pressure distillation process; solvent-deasphalted petroleum residua; shale oils, cycle oils; animal and vegetable derived fats, oils and waxes; petroleum and slack wax; and waxes produced in chemical plant processes.

In an embodiment, the feedstock's aromatics and organic nitrogen and sulfur content is reduced. This can be achieved by hydrotreating the feedstock prior to the hydroconversion. Contacting the feedstock with a hydrotreating catalyst may serve to effectively hydrogenate aromatics in the feedstock and to remove N- and S-containing compounds from the feed.

The conditions under which the present processes are carried out will generally include a temperature within a range from about 390° F. to about 800° F. (199° C. to 427° C.). In an embodiment, the temperature is in the range of from 500° F. to 800° F. (260° C. to 371° C.), and in another embodiment, a temperature in the range from about 550° F. to about 700° F. (288° C. to 371° C.). In a further embodiment, the temperature may be in the range from about 590° F. to about 675° F. (310° C. to 357° C.). The pressure may be in the range from about 50 to about 5000 psig, and typically in the range from about 100 to about 2000 psig.

Typically, the feed rate to the catalyst system/reactor during dewaxing processes of the present invention may be in the range from about 0.1 to about 20 h⁻¹ LHSV, and usually from about 0.1 to about 5 h⁻¹ LHSV and, in one embodiment from 0.5 to about 2 h⁻¹ LHSV. Generally, processes of the present invention are performed in the presence of hydrogen. Typically, the hydrogen to hydrocarbon ratio may be in a range from about 2000 to about 10,000 standard cubic feet H₂ per barrel hydrocarbon feed, and usually from about 2500 to about 5000 standard cubic feet H₂ per barrel hydrocarbon feed.

The per-pass conversion of the n-paraffins in the feedstock to lighter products is generally between 25 and 99%, and mostly between 40 and 80%.

The present zeolites can be loaded with a hydrogenation function metal to create a useful catalyst for n-paraffin hydroconversion. The present zeolites, e.g., PWO-type zeolites, such as PST-21 zeolite, have been found to surprisingly provide high conversion of n-paraffins to lighter n-paraffins with minimal iso-paraffin production. The catalytic hydroconversion works so well, no separation step is needed before the product of the hydroconversion is passed to a steam cracker.

The normal paraffin-rich product recovered from the hydroconversion can then be passed to a steam cracker. The product recovered from the present hydroconversion process, thanks to the use of the present catalyst based on a zeolite having the defined characteristics, does not require any separation step before it is fed to a steam cracker. The steam cracking process is known in the art. Steam cracking a hydrocarbon feedstock produces olefin streams containing olefins such as ethylene, propylene, and butenes. The present hydroconversion process provides an excellent feedstock for a steam cracker.

### Example 1

### Synthesis of PWO Zeolite

Following references 1 and 2, PWO was synthesized from a gel with the following composition: 1SiO₂:0.05Al₂O₃:0.5ROH:1HF:5H₂O, where ROH is 1,2,3-trimethylimidazolium hydroxide. In a typical synthesis 6.45 g of an aqueous solution of 1,2,3-trimethylimidazolium hydroxide (concentration of 1.86 mmol OH⁻/g or 23.8 wt. %) was mixed with 0.23 of Reheis F-2000 aluminum hydroxide in a 23 mL Teflon cup. Then 5.0 g of tetraethylorthosilicate was added and the mixture was covered and magnetically stirred overnight at room temperature. Then the mixture was uncovered, and ethanol and water were allowed to evaporate until a mass of 4.19 g was reached. Finally, 1.0 g of aqueous hydrofluoric acid (48 wt. %) was added and the mixture was homogenized. The Teflon reactor was sealed inside a metal Parr reactor and heated to 170° C. with tumbling at 43 rpm for 11 days. The product was recovered by filtration and washed with copious amounts of water and then dried in air at 85° C.

The material was calcined in air by placing a thin bed in a calcination dish and heated in a muffle furnace from room temperature to 120° C. at a rate of 1° C./min. and held for 2 hours. Then, the temperature is ramped up to 540° C. at a rate of 1° C./min. and held for 5 hours. The temperature is ramped up again at 1° C./minute to 595° C. and held there for 5 hours. The material was then allowed to cool to room temperature.

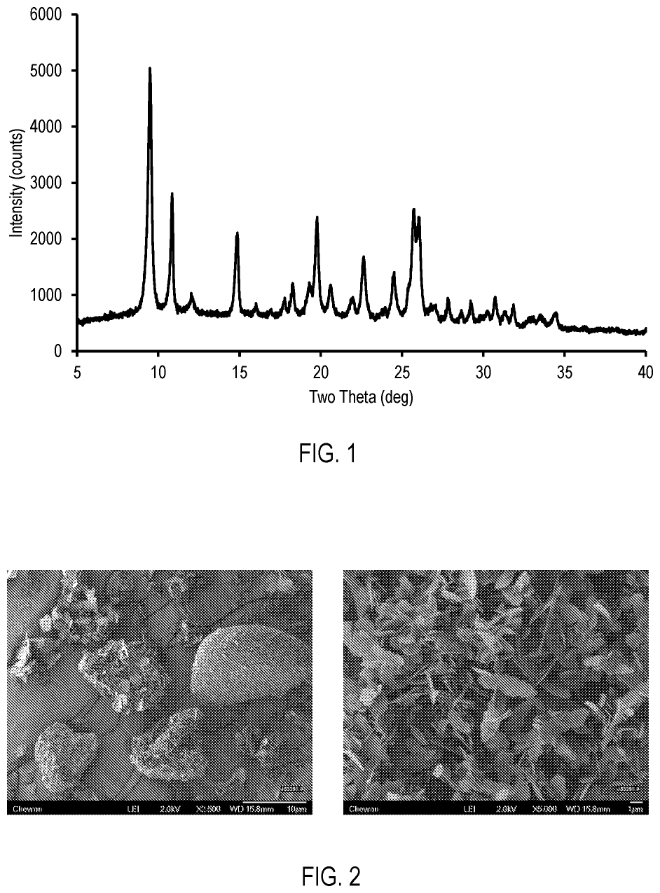

An XRD pattern of the calcined material is shown in FIG. 1. SEM images of the material are in FIG. 2. The nitrogen micropore volume was found to be 0.25 cc/g (t-plot analysis). The composition of the material was analyzed using ICP and found to be 38.1% Si and 3.66% Al, which corresponds to a silica to alumina ratio (SAR) of 20. The Bronsted acid site density was measured to be 708 (pmol H+)/g by n-propylamine TPD.

### Example 2

### Constraint Index Determination

The calcined molecular sieve of Example 1 was pelletized at 4-5 kpsi and crushed and meshed to 20-40. Then, 0.47 g of the dehydrated catalyst as determined by TGA at 600° C. was packed into a % inch stainless steel tube with catalytically inactive alundum on both sides of the zeolite catalyst bed. A Lindburg furnace was used to heat the reactor tube. Helium was introduced into the reactor tube at 10 mL/min and at atmospheric pressure. The reactor was heated to 427° C. and a 50/50 (w/w) feed of n-hexane and 3-methylpentane was introduced into the reactor at a rate of 8 μL/min with a helium carrier gas of 10 mL/min. Feed delivery was made via an Isco pump. Direct sampling into a gas chromatograph (GC) began after 15 minutes of feed introduction.

The Constraint Index value calculated from the GC data using methods known in the art and was found to be 8.3 at a temperature of 427° C. and a feed conversion of 24.6%.

### Example 3

### Palladium Exchange of Example 1

For the palladium exchange to 0.5 wt. % Pd, 1.6 g of calcined material was combined with 15.3 g of DI water and 7.0 g of 0.156 N NH₄OH solution followed by 1.6 g of palladium solution that was prepared by combining 0.36 g palladiumtetraamine dinitrate in 21 g DI H₂O and 3 g of 0.148N ammonium hydroxide solution. The pH was then checked, and if necessary adjusted to 10 by adding concentrated ammonium hydroxide dropwise until pH=10 was reached. After standing at room temperature for 3 days the pH was checked again and if necessary readjusted to 10 and allowed to sit for 1 more day. The material was recovered by filtration, washed with DI water, and dried in air overnight at 85° C. The Pd form material was calcined in dry air by heating at 1° C./min ramp to 120° C. and holding for 180 min, and then heating at 1° C./min to 482° C. and holding for 180 min. Finally, the material was pelletized at 5 kpsi, crushed and sieved to 20-40 mesh.

### Example 4

Hydroconversion of n-Decane

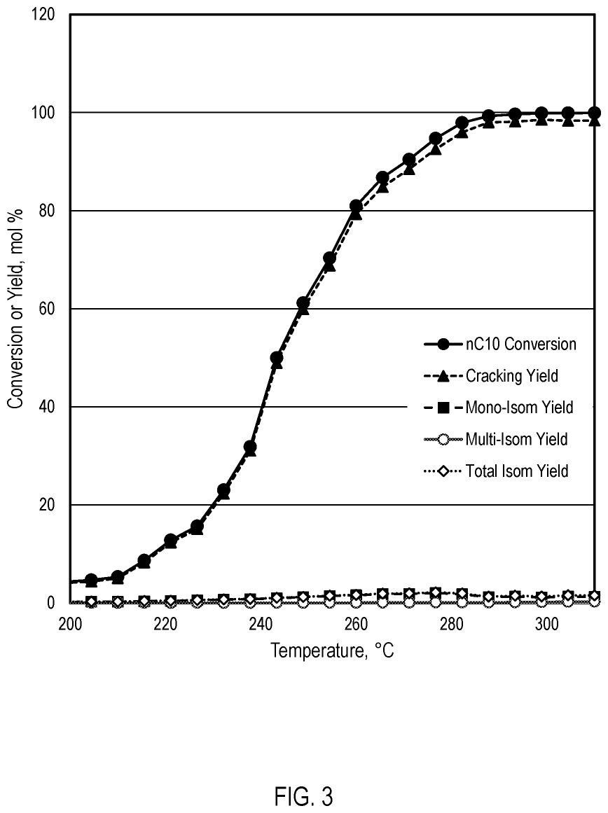

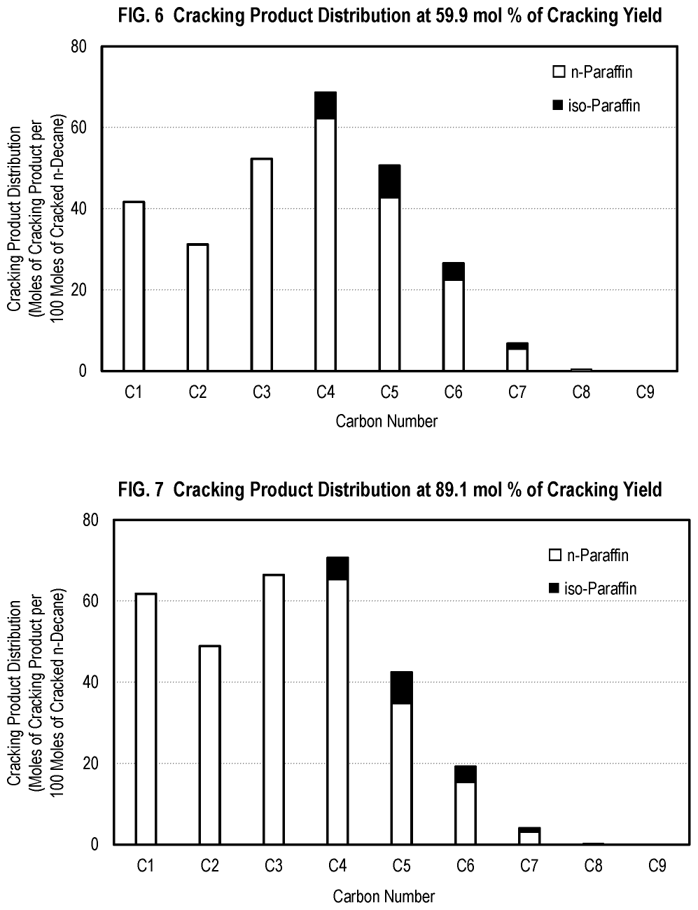

For catalytic testing, 0.5 g of the Pd/PWO catalyst (this was the weight of the dehydrated sample as determined by TGA at 600° C.) from Example 3 was loaded in the center of a 23 inch-long by 0.25 inch outside diameter stainless steel reactor tube with alundum loaded on both sides of the molecular sieve bed (a total pressure of 1200 psig; a down-flow hydrogen rate of 12.5 mL/min, when measured at 1 atmosphere pressure and 25° C.; and a down-flow liquid feed rate of 1 mL/hour). The catalyst was first reduced in flowing hydrogen at 315° C. for 1 hour. The reaction was carried out from 230 to 310° C. Products were analyzed by on-line capillary gas chromatography (GC) approximately once every sixty minutes. Raw data from the GC was collected by an automated data collection/processing system and hydrocarbon conversions were calculated from the raw data. Conversion is defined as the amount n-decane reacted in mol % to produce products including both (i) cracking products (C₉₋) and (ii) isomerization products (iso-C₁₀ isomers). The yield of iso-C₁₀ is expressed as mole percent of other C₁₀ isomer products of n-decane. The yield of cracking products (smaller than C₁₀) is expressed as mole percent of n-decane converted to cracking products. The results are shown in FIGS. 3-7.

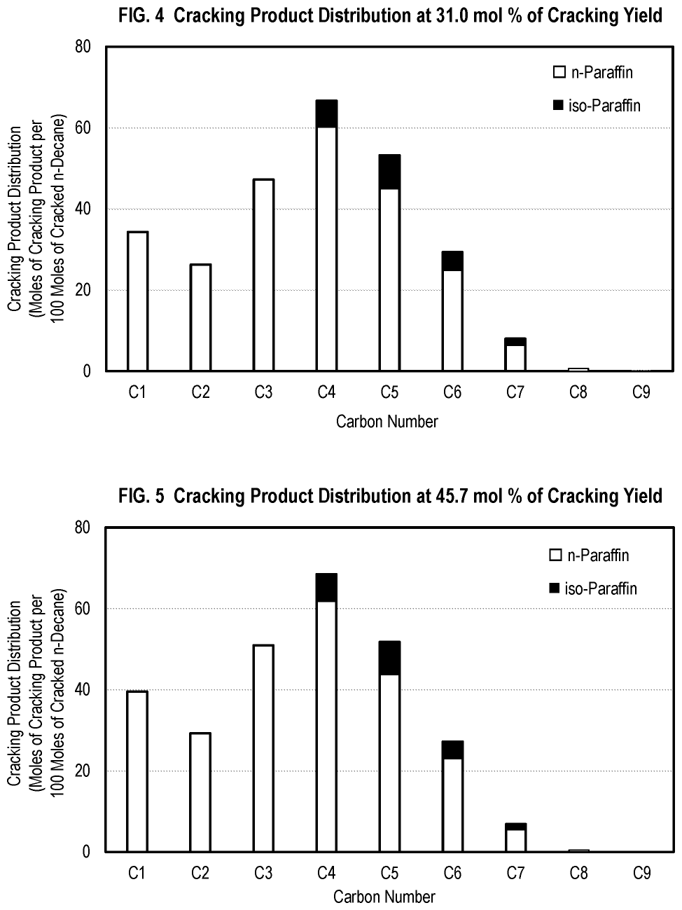

The results show that the more than 95% of the n-decane feed is converted. The conversion of n-decane increases with the increasing reaction temperature. As shown in FIG. 3 there is nearly complete conversion to cracking products at all temperatures studied, with only a small yield of isomerization products. An important feature of the catalyst of this example is the selective hydrocracking of n-decane to normal paraffin rich lighter products. As shown in FIGS. 4-7, the cracking products (C₄-C₉) consist predominantly of normal paraffins over iso-paraffins in the cracking yield range of 31 to 90 mol. %.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process for hydroconversion of normal paraffins, comprising:
subjecting a hydrocarbon feedstock comprising at least 5 wt. % normal paraffins to a hydroconversion reaction under hydroconversion conditions in the presence of a zeolite-based catalyst with a void greater than 0.35 nm in diameter accessible through channels with a shorter diameter greater than 0.30 nm and a longer diameter of less than 0.50 nm.

2. The process of claim 1, wherein the zeolite of the catalyst comprises a MVY, VSV, JSN, PWO, DFT, VNI, ASV, EPI, LOV, RSN, ETV, ATT, CGS, OWE, or CDO framework type.

3. The process of claim 1, wherein the zeolite of the catalyst comprises PWO-type zeolite.

4. The process of claim 1, wherein the feedstock comprises at least 20 wt. % normal paraffins.

5. The process of claim 1, wherein the feedstock comprises at least 50 wt. % normal paraffin.

6. The process of claim 1, wherein the feedstock is a petroleum feedstock or a petroleum based feedstock.

7. The process of claim 1, wherein the feedstock is subjected to a hydrotreatment prior to the hydroconversion reaction.

8. The process of claim 1, wherein the per-pass conversion of the normal paraffins in the feedstock is between 25 and 99%.

9. The process of claim 1, wherein a PWO-type zeolite is loaded with a hydrogenation function metal.

10. The process of claim 9, wherein the hydrogenation function metal comprises a noble metal.

11. The process of claim 10, wherein the noble metal comprises Pd, Pt, Au or a mixture thereof.

12. The process of claim 10, wherein the hydrogenation function metal component comprises Ni, Mo, W, their sulfides, or a mixture thereof.

13. A process for preparing a catalyst for hydroconversion of normal paraffins comprising:
a) choosing a zeolite that has a pore system with access through channels less than 0.45 nm in diameter and expansions greater than 0.5 nm in diameter;
b) confirming the zeolite in n-C₁₀ hydrocracking exhibits an iC₄/nC₄ in the product less than 0.5; and
c) loading the zeolite with a hydrogenation function metal to thereby prepare a hydroconversion catalyst.

14. The process of claim 13, wherein a PWO-type zeolite is loaded with a hydrogenation function metal.

15. The process of claim 13, wherein the hydrogenation function metal comprises a noble metal.

16. The process of claim 15, wherein the noble metal comprises Pd, Pt, Au or a mixture thereof.

17. The process of claim 15, wherein the hydrogenation function metal component comprises Ni, Mo, W, their sulfides, or a mixture thereof.

18. The process of claim 13 wherein the iC₄/nC₄ ratio in the product is less than 0.25.

19. A process for hydroconversion of normal paraffins, comprising:
subjecting a hydrocarbon feedstock comprising at least 20 wt. % normal paraffins to a hydroconversion reaction under hydroconversion conditions in the presence of the hydroconversion catalyst prepared in claim 13.

20. The process of claim 19, wherein the zeolite of the catalyst comprises PST-21.

21. The process of claim 1 or 19, wherein a product is recovered from the reaction and passed to a steam cracker.

22. The process of claim 1 or 19, wherein the product is passed to a steam cracker with no separation step before being fed to the steam cracker.

23. The process of claim 1, 13, or 19, wherein the zeolite of the catalyst is a channel based zeolite with a d-sphere/d-avg<1.5.

24. A zeolite-based catalyst that is loaded with a hydrogenation function metal, and the zeolite has voids greater than 0.35 nm in diameter accessible through channels with a shorter diameter greater than 0.30 nm and a longer diameter of less than 0.50 nm, and which in n-C₁₀ hydrocracking exhibits an iC₄/nC₄ product ratio of less than 0.5.
